(19) United States
(12) Patent Application Publication
(10) Pub. No.: US 2024/0288099 A1
(43) Pub. Date: Aug. 29, 2024

(54) A METHOD OF MANUFACTURING A DOUBLE-WALLED ELBOW PIPE SEGMENT, A PIPE ASSEMBLY

(71) Applicant: Pipeflex Systems Ltd, Bedlington (GB)

(72) Inventor: Malcolm BIRCHALL, Bedlington (GB)

(21) Appl. No.: 18/570,221

(22) PCT Filed: Jun. 14, 2022
(86) PCT No.: PCT/GB2022/051495

§ 371 Date: Dec. 14, 2023

(30) Foreign Application Priority Data
Jun. 16, 2021 (GB) 2108586.5

(51) Int. Cl. F16L 9/18; B21C 37/15; B21D 7/03; F16L 43/00

(52) U.S. Cl. CPC F16L 9/18; B21C 37/154; B21D 7/03; F16L 43/001

(57) ABSTRACT

A method of manufacturing a double-walled elbow pipe segment, comprising the steps of: (a) providing an inner pipe member; (b) providing at least one first support member, and positioning said at least one first support member coaxially over said inner pipe member; (c) providing an outer pipe member and slidably positioning said assembled inner pipe member and said at least one first support member within said outer pipe member such that said at least one first support member is supportingly engaged with an outer surface of said inner pipe member and an inner surface of said outer pipe member, and (d) bending a pipe assembly of said inner pipe member, said at least one first support member and said outer pipe member into at least one first elbow section of a predetermined first angle and in a predetermined first direction between an upstream end portion and a downstream end portion of said pipe assembly.

The present disclosure relates to a method of manufacturing a double-walled elbow pipe segment, and further relates to a pipe assembly.

### BACKGROUND

Double-walled pipe systems, otherwise known as “pipe-in-pipe” systems, are typically used to convey fuel or other hazardous and/or flammable liquids, or gases, from storage tanks to dispensing pumps or appliances. Double-walled pipe systems include an inner pipe, also known as a carrier pipe, used to convey the fluid, and an outer pipe, also known as a containment sleeve, that surrounds the inner pipe. In the event that the inner pipe is damaged, or the structural integrity of the inner pipe is otherwise compromised, fluid may leak from the inner pipe but is contained within the outer pipe. This is especially important when the fluid conveyed is a hazardous product, so that the hazardous product does not escape the pipe system, contaminating the surrounding environment.

FIG. 1 shows a known double-walled pipe system 1 which includes a flexible, inner pipe 3 made from corrugated stainless steel, and a casing 7 made from polyethylene. The inner pipe 3 may be helically corrugated so as to create a circumferential and continuous channel 5 between the inner pipe 3 and the casing 7 to allow fluid flow between proximal and distal end of the pipe system, therefore allowing leak detection in case fluid is leaking out of the inner pipe 3.

FIG. 2 shows a well-known double-walled pipe elbow 11 disclosed in PCT application WO2007048368A1. The pipe elbow 11 is typically flanged or welded between connecting pipes so as to change direction. The double-walled pipe elbow 11 includes an internal elbow pipe 13 and an external elbow pipe 17 forming an annular gap 15 between them. The annular gap 15 comprises a filler 19 such as concrete that is filled through an opening 21.

Traditionally, the installation of a double-walled pipe system can be very time consuming as there are often space constraints for the fitting of the pipe system. Although deformable plastic pipe systems exist, such as those made of high density polyethylene (HDPE), these pipe systems may not be suitable for conveying hazardous fluids (e.g. fuel for generators) as they would melt in the event of a fire, making them limited in their application. Metal pipe systems are, in contrast, more applicable as they do not melt. However, the installation of metal pipe systems is more time consuming, because such pipes cannot be deformed easily. Consequently, the metal pipe system has to be prefabricated to a specific layout using flangeable or weldable elbow sections to connect and direct the pipes along a predetermined layout. The use of prefabricated pipe sections and pipe elbows (at suitable angles) can make the installation into restrictive areas such as inside internal buildings, difficult and cumbersome.

Another problem associated with such flexible metal pipe systems is that hot-working, such as welding and hot-forming may be required to manufacture and to install them. These processes are not permitted around areas with hazardous fuels and substances present, meaning that they can only be manufactured and installed in an environment isolated from such fuels and substances.

In a piping system, there are numerous occasions when a pipe ideally needs to be bent, for example when a pipe route or path is complex, non-linear and/or containing bends. Even when relatively flexible metal pipe systems are used, these systems have a large bend radius which limits their installation to large open spaces. Pipe deformation is typically achieved by putting the pipe through a former. The problem associated with this, however, is that the wall of the pipe crumples or otherwise deforms, decreasing the flow rate of fluid through the pipe. This problem is further enhanced with double-walled pipe systems, which causes unwanted ovality of the cross-sectional profile of both pipes.

Consequently, it would be desirable to mitigate at least one of the aforementioned problem. It is an object of the present invention to provide a method of manufacturing a double-walled pipe segment that is simple to install in restrictive places. It is another object of the present invention to provide a method of manufacturing a double-walled pipe segment that does not require hot-working. It is a further object of the present invention to provide a method of manufacture that reduces or removes unwanted deformation of a pipe cross-sectional profile. It is also an object of the present invention to provide a pipe assembly that is less susceptible to pipe cross-sectional profile deformation and reduction of fluid flow through the pipe.

The present invention aims to address or mitigate at least one of the aforementioned issues. The present invention provides at least an alternative to methods of manufacturing a double-walled pipe segment, and to pipe assemblies, which are associated with the prior art.

### SUMMARY OF THE INVENTION

In accordance with the present invention there is provided a method of manufacturing a double-walled elbow pipe segment in accordance with the appended claims. There is also provided a pipe assembly in accordance with the appended claims.

Viewed from a first aspect, the present invention provides a method of manufacturing a double-walled elbow pipe segment. The method comprises the steps of:
(a) providing an inner pipe member;
(b) providing at least one first support member, and positioning the at least one first support member coaxially over the inner pipe member;
(c) providing an outer pipe member and slidably positioning the assembled inner pipe member and the at least one first support member within the outer pipe member such that the at least one first support member is supportingly engaged with an outer surface of the inner pipe member and an inner surface of the outer pipe member, and
(d) bending a pipe assembly of the inner pipe member, the at least one first support member and the outer pipe member into at least one first elbow section of a predetermined first angle and in a predetermined first direction between an upstream end portion and a downstream end portion of the pipe assembly.

Thus, the at least one first support member is positioned between, and supports, both the inner pipe member and the outer pipe member. When the pipe assembly is bent into the at least one first elbow section, the at least one first support member provides sufficient support to maintain the shape of both the inner and outer pipe members through the bending process while resiliently adapting its own shape (length) to the bending pipe structure, thus allowing one or more required bend(s) to be provided at any location of a double-walled pipe and into any direction and at any angle so as to follow a desired layout of the pipe system. Further, the new method of creating double-walled elbow pipe segments facilitates installation of the pipe system in restrictive areas, and especially internal areas, since hot-working is not required. The new method also ensures that the cross sectional shape (preferably circular) of the pipe assembly is maintained, optimising the fluid flow rate through the pipe.

Advantageously, in some embodiments, step (d) may comprise bending the pipe assembly into at least one second elbow section of a predetermined second angle and in a predetermined second direction between the upstream end portion and the downstream end portion. This is advantageous because multiple elbow sections can be provided in the pipe assembly, allowing the pipe to be deformed and placed into more restrictive spaces, or according to the spatial requirements of the installation.

In some embodiments, the first direction and the second direction may be within the same plane.

In alternative embodiments, the first direction and the second direction may be within different planes.

In some embodiments, the first predetermined angle may be equal to the second predetermined angle.

In alternative embodiments, the first predetermined angle may differ from the second predetermined angle.

Advantageously, in some embodiments, the at least one first support member may be adapted to operably cover the at least one first elbow section and the at least one second elbow section.

Advantageously, in some embodiments, step (b) may further comprise providing at least one second support member and positioning the at least one second support member coaxially over the inner pipe member at the second elbow section.

Advantageously, in some embodiments, step (d) may be performed utilising a cold-forming pipe bending tool.

Advantageously, in some embodiments, the method may further comprise a step (e) verifying a minimally deformed cross-sectional profile of the inner pipe utilizing a ball bearing having a diameter adapted to tightly fit inside the inner pipe member. This is particularly advantageous as this shows whether the cross-sectional profile has deformed, and provides an indication of whether the fluid flow rate through the pipe is reduced by such deformation.

Viewed from a second aspect, the present invention provides a pipe assembly, comprising:
an inner pipe member;
an outer pipe member, adapted to operably receive the inner pipe member, so as to define an interstitial space between an outer wall of the inner pipe member and an inner wall of the outer pipe member, as well as, between an upstream end portion and a downstream end portion, and
at least one first support member, adapted to be provided coaxially within the interstitial space so as to supportingly engage the inner wall of the outer pipe member and the outer wall of the inner pipe member, when forming at least one first elbow section, and to provide a fluid path between the upstream end portion and the downstream end portion.

Thus, the at least one first support member is positioned in the interstitial space between and supports the inner pipe member and the outer pipe member. When the pipe assembly is bent into the at least one first elbow section, the at least one first support member acts as a support to maintain the shape of both the inner and outer pipe members through the bending process, while resiliently adapting its own shape (length) to the bending pipe structure, thus allowing one or more required bend(s) to be provided at any location of a double-walled pipe and into any direction and at any angle so as to follow a desired layout of the pipe system. This facilitates installation in restrictive areas, especially internal areas since hot-working is not needed. By maintaining the shape of the pipe members, the fluid flow rate through the pipe is maintained.

Advantageously, in some embodiments, the at least one first support member may be arranged around the inner pipe member in the form of a helix. This is particularly advantageous since the at least one first support member does not fully occupy the entire interstitial space between the inner and outer pipe members. By ensuring that the entirety of the interstitial space is not occupied by the at least one first support member, there is provided space for, for example, a pressure sensor to monitor leakage.

Advantageously, in some embodiments, the at least one first support member may be a coil spring having a predetermined length.

Advantageously, in some embodiments, the pipe assembly may further comprise at least one second support member adapted to be provided coaxially within the interstitial space so as to supportingly engage the inner wall of the outer pipe member and the outer wall of the inner pipe member when forming at least one second elbow section, and to provide a fluid path between the upstream end portion and the downstream end portion.

Advantageously, in some embodiments, the pipe assembly may be a fuel pipe assembly.

Advantageously, in some embodiments, the outer pipe member may comprise carbon steel.

Advantageously, in some embodiments, any one of the outer wall of the inner pipe member and the inner wall of the outer pipe member may comprise a protective coating.

Advantageously, in some specific embodiments, the protective coating may comprise zinc.

### BRIEF DESCRIPTION OF THE DRAWINGS

Embodiments of the invention are now described, by way of example only, hereinafter with reference to the accompanying drawings, in which:

FIG. 1 (PRIOR ART) illustrates a known double-walled pipe system;

FIG. 2 (PRIOR ART) illustrates another known double-walled pipe elbow;

FIG. 3 illustrates a pipe assembly, including an inner pipe and outer pipe, in (a) perspective view, (b) rear elevation view, (c) front elevation view, (d) section view through A-A, (e) detailed section view of the pipe bend area, and (f) section view through B-B;

FIG. 4 illustrates a support member, in the form of a coil spring, in (a) perspective view, and (b) partial side elevation view;

FIG. 5 illustrates a pipe assembly, in (a) disassembled state before forming an elbow bend, showing the inner pipe, support member and outer pipe, (b) perspective view, before forming an elbow bend, and (c) perspective view after forming an elbow bend;

FIG. 6 illustrates (a) schematic diagram of a pipe bending apparatus before forming an elbow bend, (b) schematic diagram of a pipe bending apparatus after forming an elbow bend, and (c) representation of a pipe bending apparatus in use;

FIG. 7 illustrates an end cap, in (a) perspective view, (b) top elevation view, (c) rear elevation view, (d) front elevation view, and (e) section view through C-C;

FIG. 8 illustrates a pipe assembly including two couplers (instead of end caps), in (a) perspective view, (b) side elevation view, (c) rear elevation view, (d) front elevation view, (e) section view through D-D, (f) detailed section view showing one end of the pipe assembly;

FIG. 9 illustrates the pipe assembly of FIG. 8, in an exploded view; and

FIG. 10 illustrates a pipe assembly, in (a) disassembled state before forming an elbow bend, showing the inner pipe, support member and outer pipe, and (b) assembled state after forming two elbow bends, and including two end caps of FIG. 7.

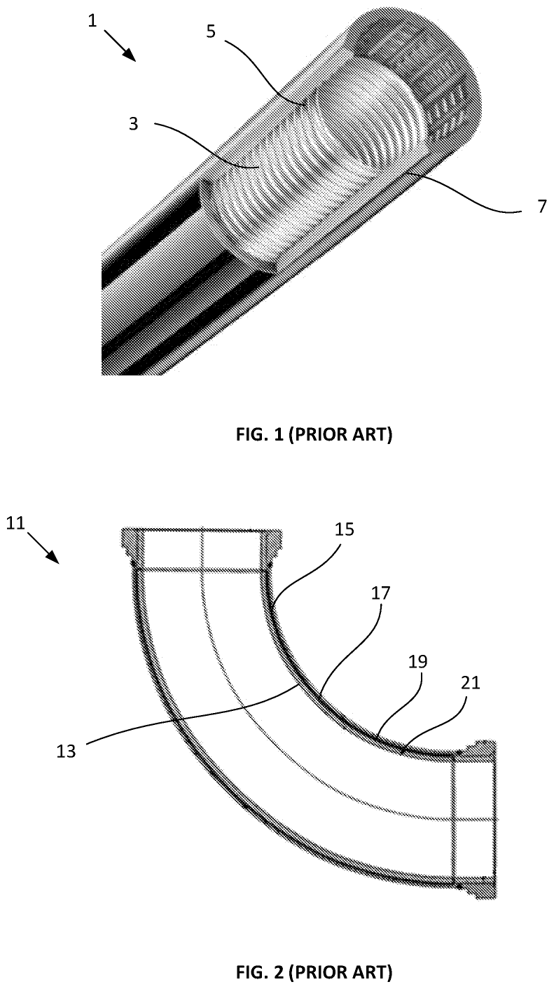

### DETAILED DESCRIPTION

The described example embodiment relates to a method of manufacturing a double-walled elbow pipe segment, and a pipe assembly according to the present invention.

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description. In particular, the words “upstream” and “downstream” designate directions which refer to the direction of fluid flow within the pipe.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

Reference will now be made to the drawings, which depict one or more embodiments described in this disclosure. However, it will be understood that other embodiments not depicted in the drawings fall within the scope of this disclosure. Like numbers used in the figures refer to like components, steps and the like. However, it will be understood that the use of a number to refer to a component in a given figure is not intended to limit the component in another figure labelled with the same number. In addition, the use of different numbers to refer to components in different figures is not intended to indicate that the different numbered components cannot be the same or similar to other numbered components. The figures are presented for purposes of illustration and not limitation. Schematic drawings presented in the figures are not necessarily to scale.

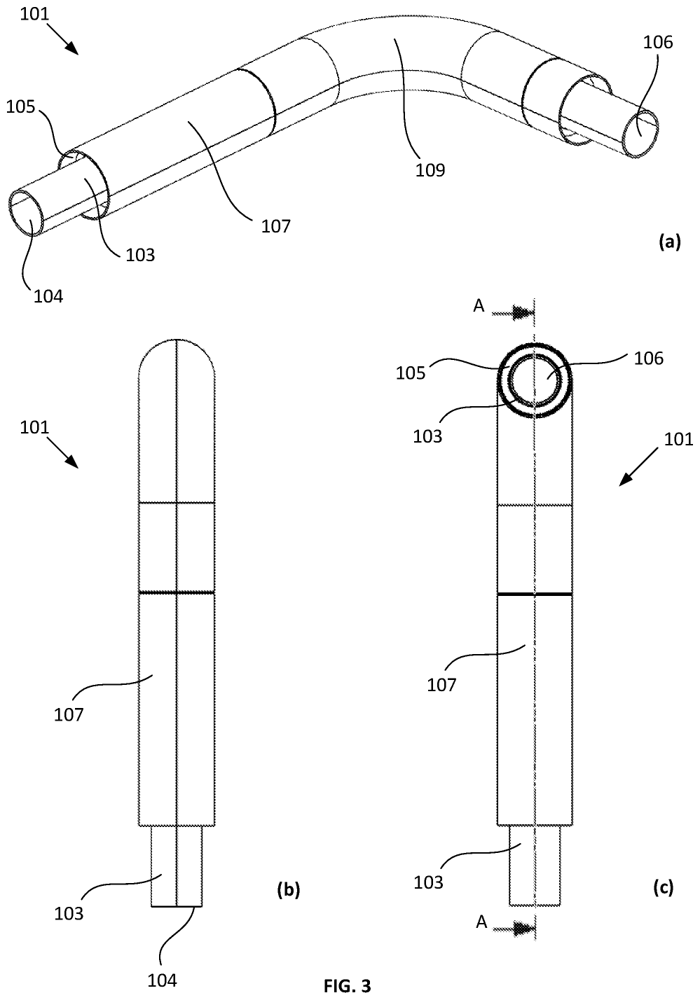

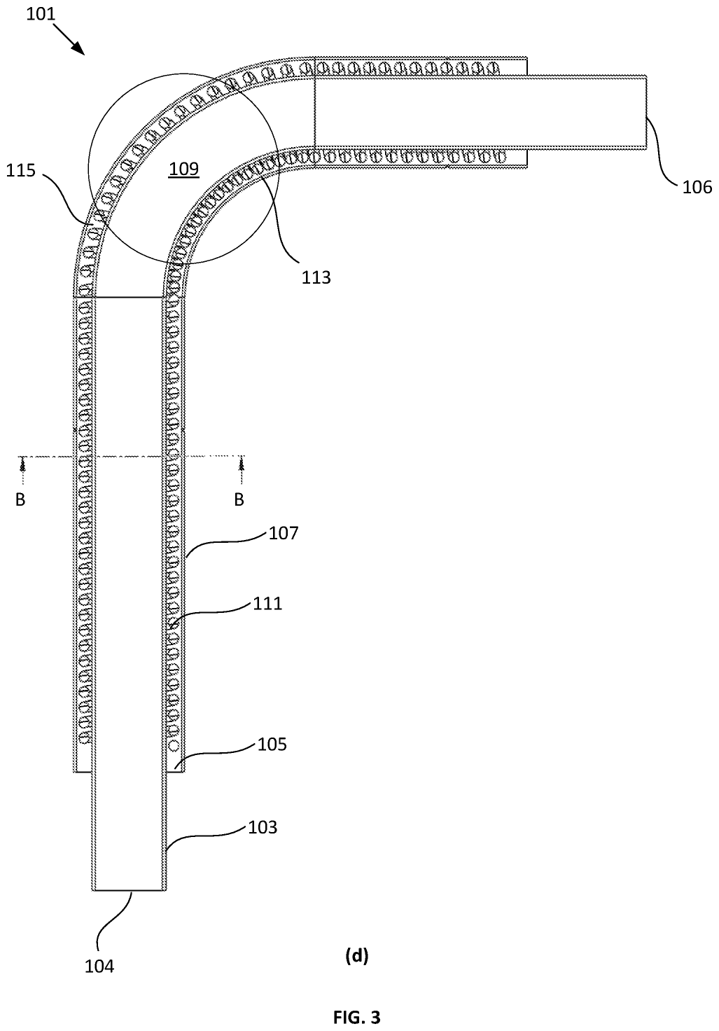

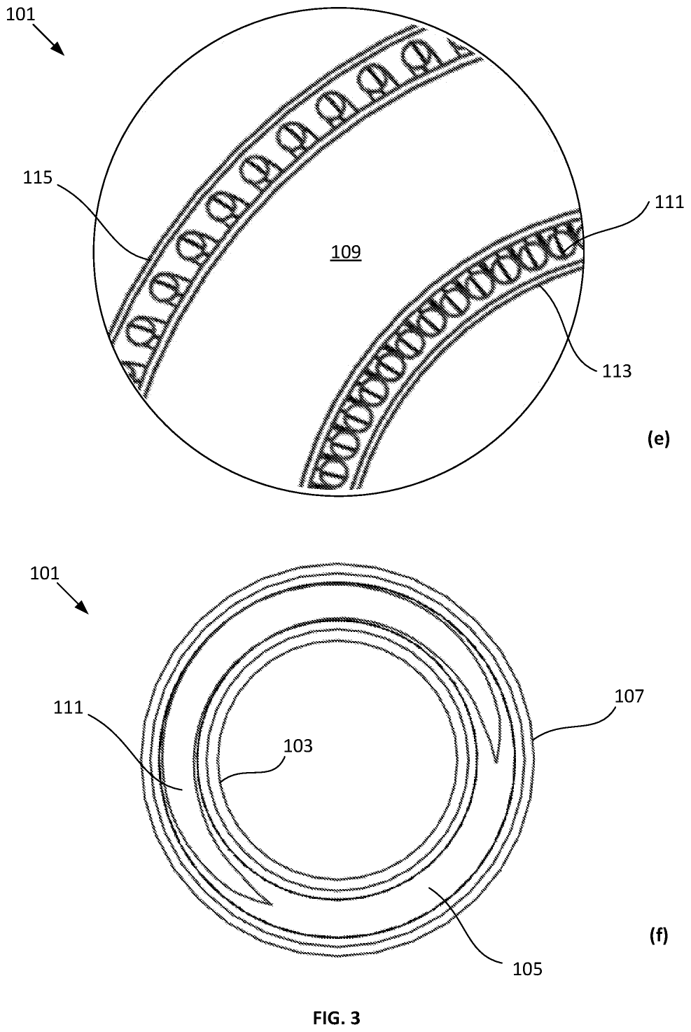

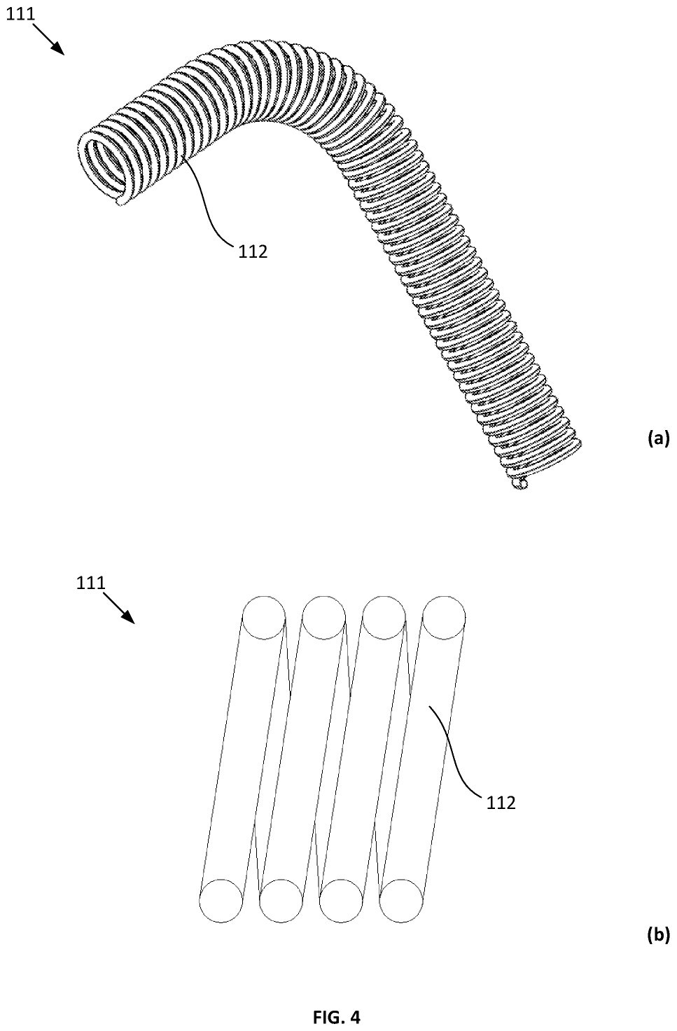

Referring now to FIG. 3, which shows an example embodiment of a bent pipe assembly 101 shaped by using the method of the present invention. The pipe assembly 101 includes an inner pipe 103 surrounded by an outer pipe 107 so as to form an interstitial space 105 (i.e. a gap) in between an outer surface of the inner pipe 103 and an inner surface of the outer pipe 107. The pipe assembly 101 has a upstream end 104 and a downstream end 106. The inner pipe 103 defines a flow passageway through which a fluid flows from the upstream end 104 to the downstream end 106. In this particular example, the inner pipe 103 conveys fuel through the flow passageway (i.e. the inner pipe 103). However, it is envisaged that other fluids may be transferred, such as, but not limited to, liquids, gases, slurries, powders or small solids. In this example embodiment, the inner pipe 103 is arranged coaxial to the outer pipe 107, such that the interstitial space 105 is circumferentially equally spaced along the profile of the pipe assembly 101 (i.e. annular cross section). The completed pipe assembly 101 has an elbow bend 109 at a section between the upstream end 104 and the downstream end 106. In this example embodiment, the elbow bend 109 goes through an angle of 90 degrees such that the linear portions of the pipe assembly 101 before and after the elbow bend 109 are displaced and arranged perpendicular to one another. Other angles are also envisaged, such as, but not limited to, 45 degrees, 30 degrees, 60 degrees, or 75 degrees, for example. In fact, any suitable angle may be created on location during installation of the pipe system. In one preferred embodiment, the bend radius of the elbow bend 109 is about five times the diameter of the outer pipe 107 (i.e. 5D). In this example embodiment, the inner pipe 103 and the outer pipe 107 are made of carbon steel. However, other metals are also envisaged such as stainless steel, as will be appreciated to the skilled person. Further, any one or more of the outer surface of the inner pipe 103, the inner surface and the outer surface of the outer pipe 107 may further be provided with a protective zinc coating.

As best shown in FIGS. 3(d) and 3(e), a support member 111 is positioned in the interstitial space 105 to engage both the inner pipe 103 and the outer pipe 107. In this particular example embodiment, the support member 111, may be a coil spring with coils 112 (see FIG. 4) in the form of a helix. However, the support member 111 may be of any other suitable shape or configuration adapted to supportingly engage with the inner surface of the outer pipe 107 and the outer surface of the inner pipe 103, as well as, provide a fluid path within the interstitial space 105 between the upstream end 104 and the downstream end 106. The coil spring 111 is arranged coaxial with both the inner pipe 103 and the outer pipe 107, and winds around and along the interstitial space 105. As seen in the close-up of FIG. 3(f), the sectional profile of the coil spring 111 may not fully occupy the entire space 105 at a given cross-section. This arrangement is advantageous to allow relative movement between the coil spring 111 and the inner and outer pipe 103, 107 during the formation of the elbow 109. The required fluid path between the upstream end 104 and the downstream end 106 allows the use of a pressure sensor to quickly identify leakage of fluid from the inner pipe 103 to the interstitial space 105.

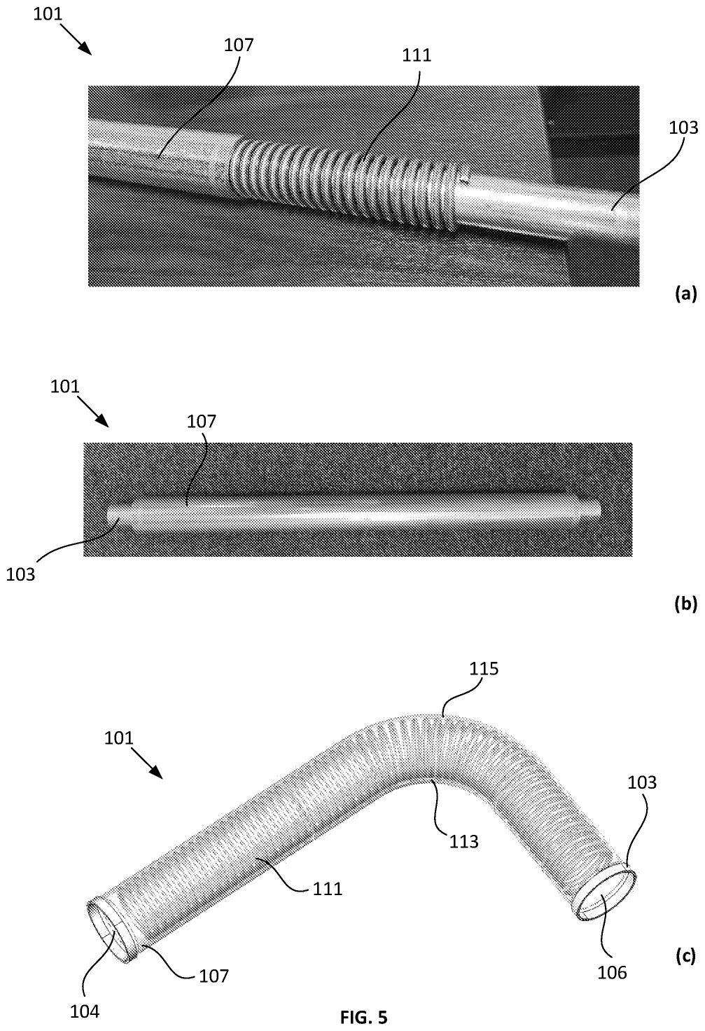

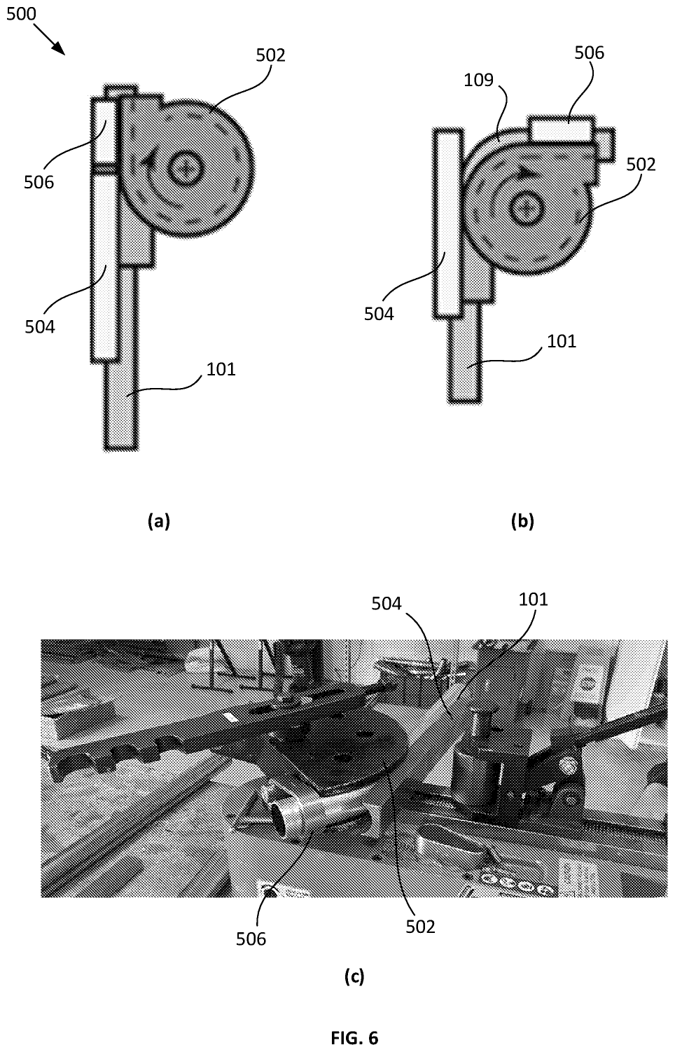

The method of manufacturing a double-walled elbow pipe segment, using a pipe bending apparatus 500, will now be described with reference to FIGS. 5 and 6. Referring firstly to FIGS. 5(a) and 5(b), the inner pipe 103 is provided, and the coil spring 111 is arranged coaxially over the outer surface of the inner pipe 103. In this particular example, the coil spring 111 spans along a suitable portion of the inner pipe 103. In other embodiments, the coil spring 111 may span the entirety of the length of the inner pipe 103 allowing multiple bends at different locations of the pipe section 101. The outer pipe 107 then slides over the assembled coil spring 111 and inner pipe 103, which places the coil spring 111 into engagement with and between the inner pipe 103 and the outer pipe 107. As illustrated in FIG. 5(c), a finished elbow bend 109 (transparent) is provided in the assembled pipe assembly 101 at a location between the upstream end 104 and the downstream end 106. This forms an inner bend 113 and an outer bend 115 on a opposite side having a radius larger than the radius of the inner bend 113.

Turning now to FIG. 6, a pipe bending apparatus 500 receives the pipe assembly 101 including the assembled inner pipe 103, coil spring 111 and outer pipe 107. The pipe bending apparatus 500 includes a suitable bend die 502 and a pressure die 504. The pressure die 504 exerts pressure to move the pipe assembly 101 towards the bend die 502, and then the bend die 502 rotates to create an elbow bend 109 within a section of the pipe assembly 101. The pipe assembly 101 may be driven using hydraulics towards the bend die 502. During the bending process, a clamp die 506 holds the pipe assembly 101 close to the bend die 502 to follow the curvature of the bend die 502. The bend angle of the elbow bend 109 may be determined by the shape of the bend die 502 or may simply be determined by stopping the bending process at the desired angle. In a particular example embodiment, a pipe diameter ‘D’ of approximately 5 cm (2 inches) may preferably use a bend radius of about 5D (i.e. five times the pipe diameter).

This bending process avoids any cutting, welding and other hot-working processes. Since the coil spring 111 engages and supports both the inner pipe 103 and the outer pipe 107 during the bending process, the section profile of both pipes 103, 107 is maintained, avoiding ovality and crumpling of the pipe walls.

If an additional elbow bend (or bends) is required, then the pipe assembly 101 is again inserted into the pipe bending apparatus 500, and the above mentioned process is repeated to provide a bend at any angle and direction relative to the previous bend, i.e. the additional elbow bend(s) may be in the same, or different, plane, angle or direction relative to elbow bend 109. In some example embodiments, the coil spring 111, or other support member, is positioned over the inner pipe 103 and the elbow section which forms elbow bend 109, and the elbow section which forms the additional elbow bend(s). In some other example embodiments, separate coil springs 111, or other support members, may be positioned over the inner pipe 103 at each one of the intended additional elbow section(s). The method of bending the pipe assembly 101 using a pipe bending apparatus 500 is one example embodiment of bending the pipe assembly 101. It is envisaged that other methods may be used, as will be appreciated by the skilled person, such as, but not limited to, compression bending, ram bending and three-roll bending, for example.

In one example embodiment, after the pipe assembly 101 is bent into a desired shape, a ball bearing (not shown) may be used to examine the cross section of the inner pipe. Here, a ball bearing having a diameter slightly smaller than the diameter of the inner pipe 103 is passed through the inner pipe 103 passageway to identify whether the pipe assembly 101 has been deformed during the pipe bending process. If the wall of the inner pipe 103 has been deformed, then the ball bearing does not pass through when pushed through from one of the upstream end 104 and downstream end 106, to the other of the upstream end 104 and the downstream end 106. However, if any deformations of the wall of the inner pipe 103 are within a predetermined minimum, then the ball bearing passes through when pushed through from one of the upstream end 104 and downstream end 106, to the other of the upstream end 104 and the downstream end 106, thus, verifying that the cross-sectional profile of the inner pipe 103 is still within limits.

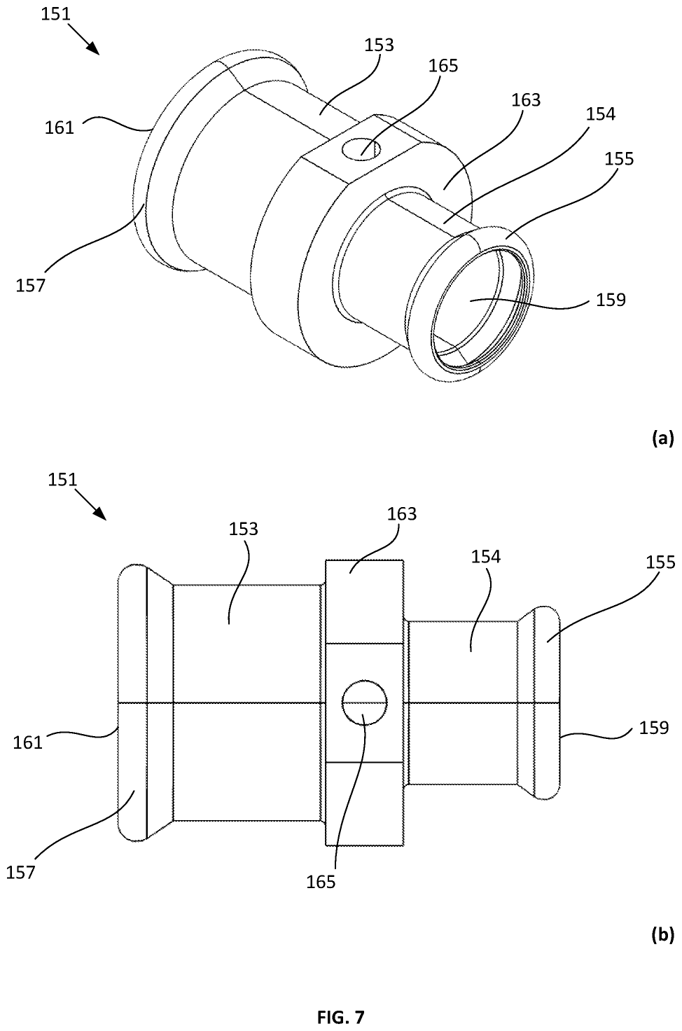

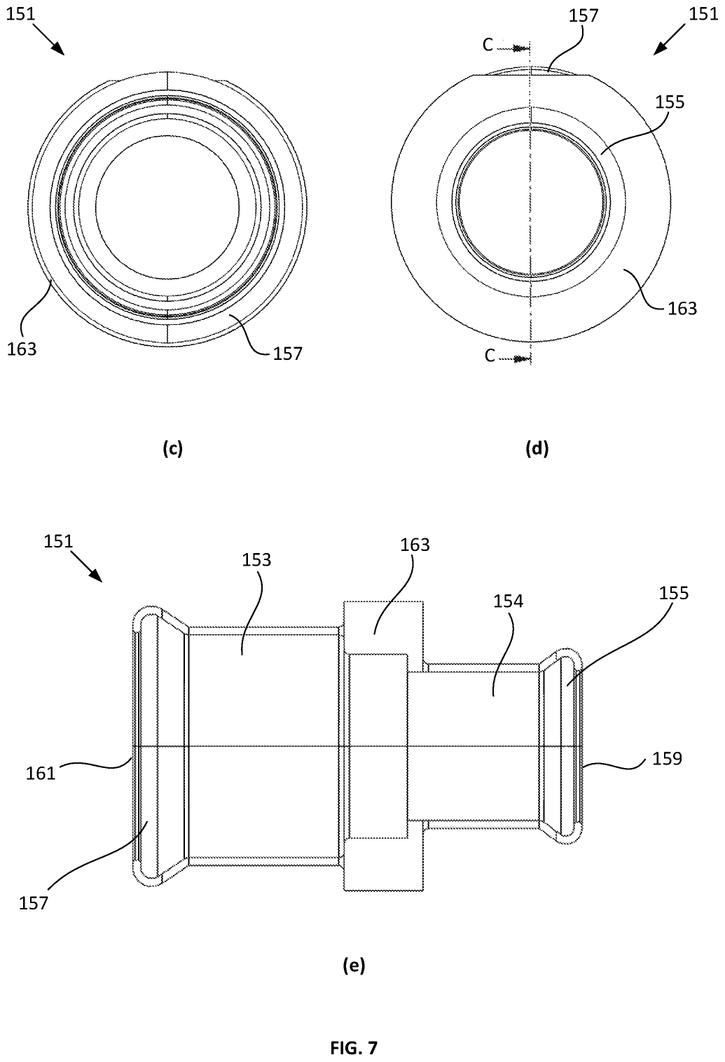

End-stops may be used to seal off the whole double-walled pipe or reducers/adaptors may be used seal off the interstitial space and continue with the inner pipe. Typically, such end caps/stops, or adaptors are either welded on, or screwed onto a suitable thread at the end portion of the pipe system. Often, the ends of known double-walled pipe systems may be sealed by placing a tapered section of a stopper or end cap over the outer pipe, cutting at the inner pipe, and welding the stopper to the pipe system. FIG. 7 shows an exemplary embodiment of an end cap 151 or crimpable pipe closure that can be coupled to the double-walled pipe without welding or threading. The end cap 151 has an upstream end 159, a downstream end 161 and a first cylindrical body 153 between the upstream end 159 and the downstream end 161. A second cylindrical body 155 is coaxially extending from the first cylindrical body towards the upstream end 159.

Upstream and downstream ends of respective first and second cylinder bodies 153, 154 may be provided with a crimpable lip 157, 155, such as, the Geberit Mapress coupling (i.e. including annular interior seals (O-rings). The first cylindrical body 153 may further be provided with a fluid port 165 into the interstitial space of the pipe system 101 for use with a leak detection system. Here, pressure sensor(s) or gas sensors may be coupled to the fluid port 165 to detect leaks from the inner fuel pipe 103 into the interstitial space 105.

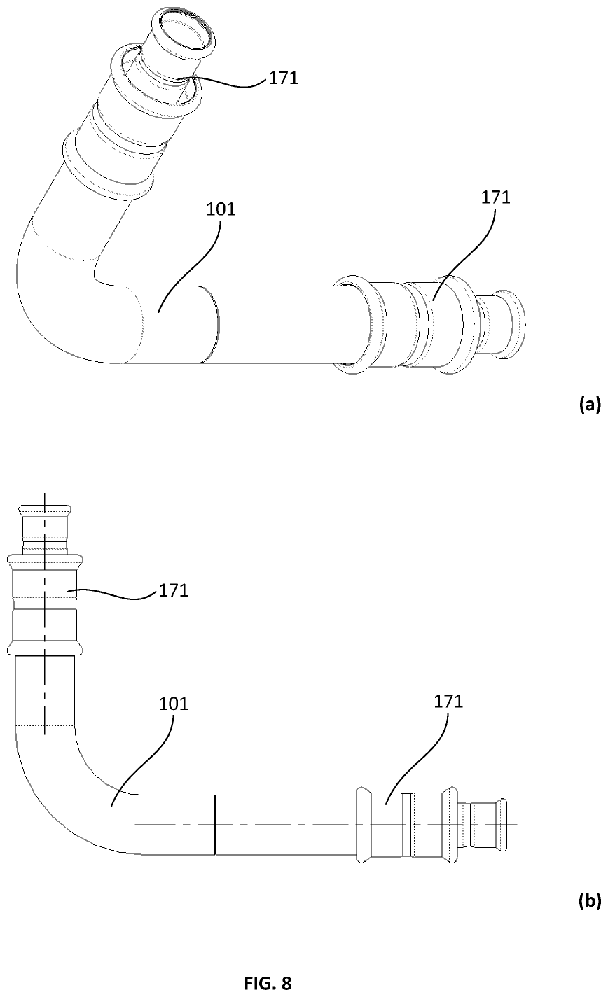

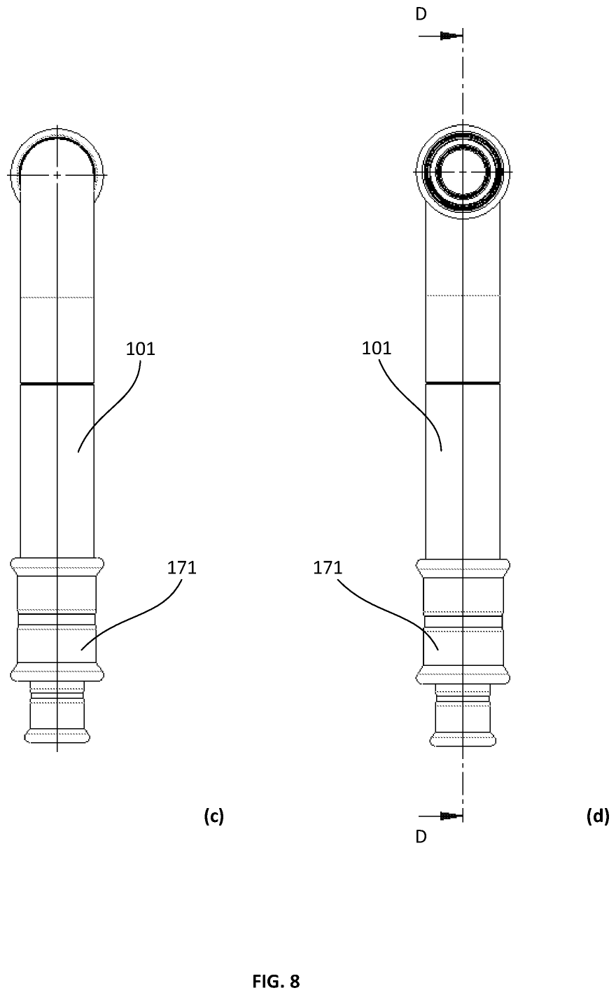

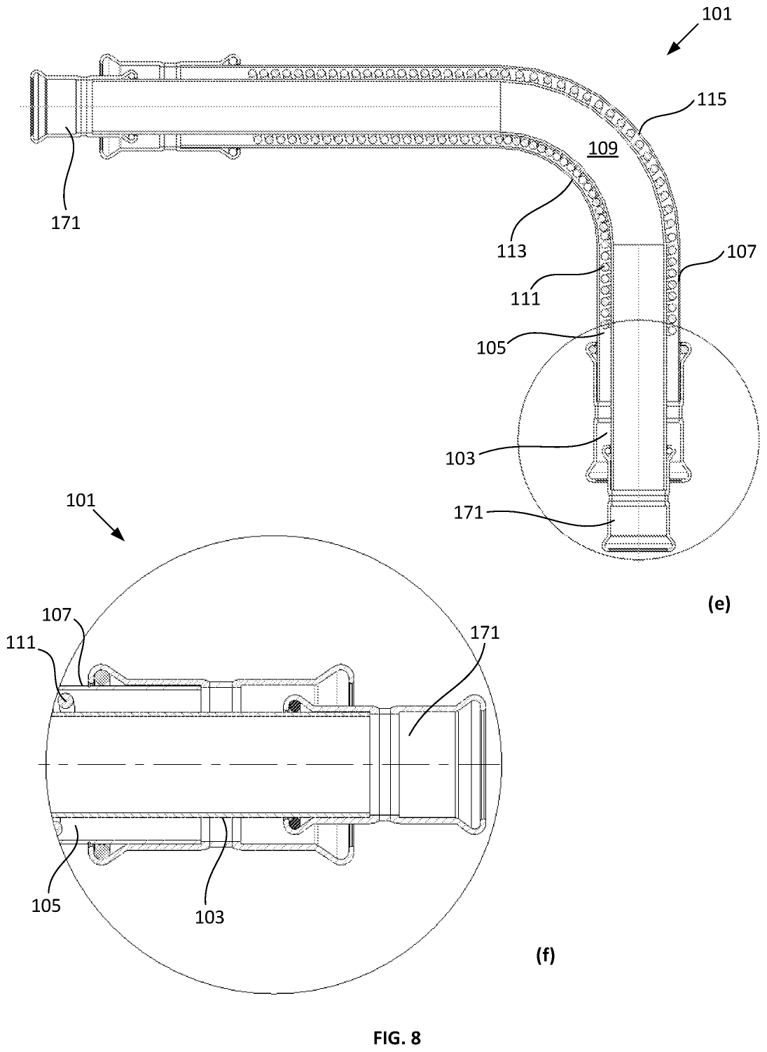

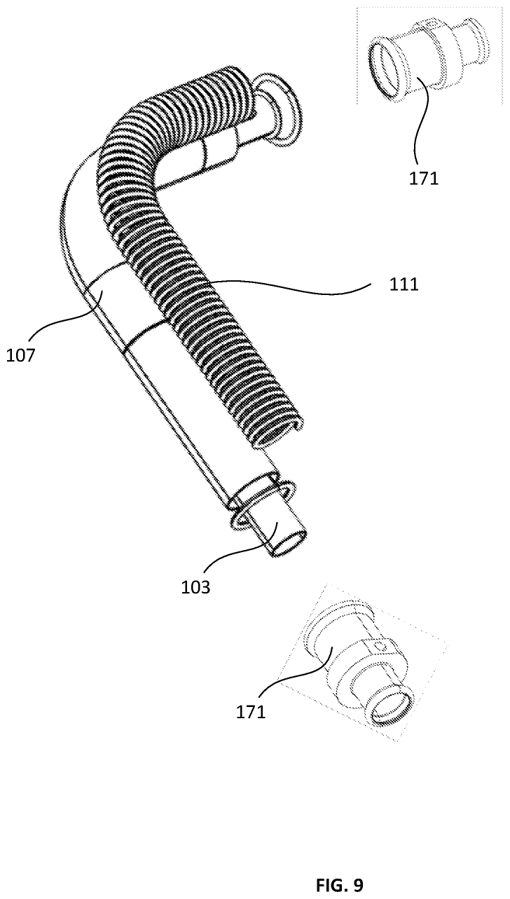

During use, the end cap 151 or suitable couplers 171 are simply coupled onto one or both ends of the pipe assembly 101 using a crimping tool (e.g. the Geberit Mapress crimping tool). As seen in the example embodiment of FIGS. 8 and 9, couplers 171 are coupled to both the upstream end 104 and the downstream end 106 of the pipe assembly 101. Each coupler 171 has a first smaller bore on one end which receives an inner pipe 103 on the end of the pipe assembly 101. Each coupler 171 also has second larger bore on another end which receives the outer pipe 107 of the pipe assembly 101. The coupler 171 may then be crimped directly onto the pipe assembly 101.

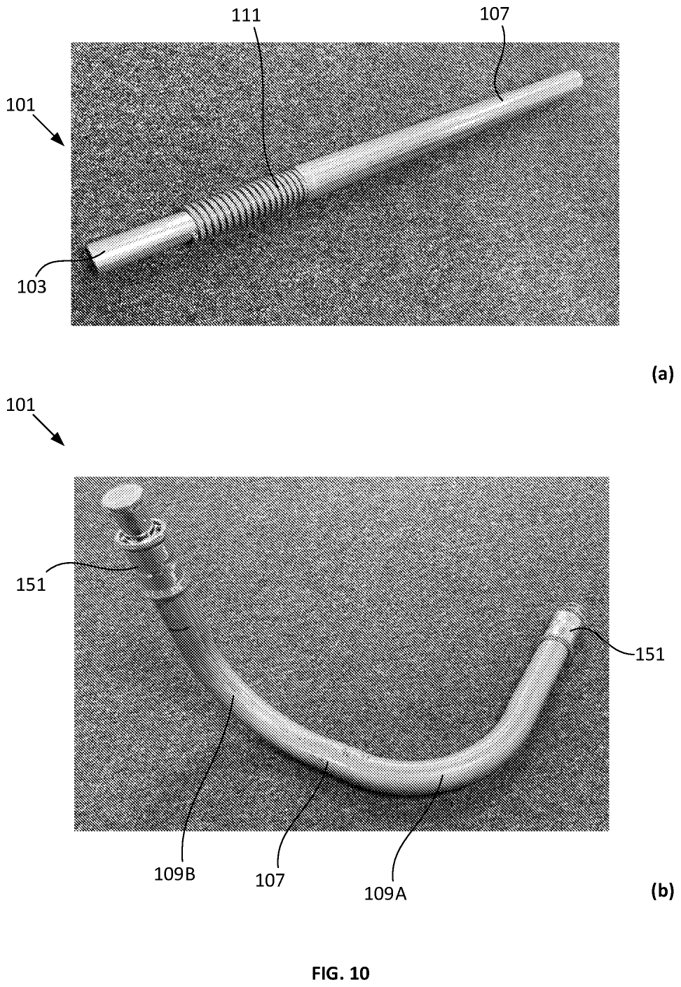

FIG. 10 shows another example embodiment of a pipe assembly 101 including a first elbow bend 109A proximate the upstream end, and a separate second elbow bend 109B proximate the downstream end. In this particular example embodiment, the first elbow bend 109A and the second elbow bend 109B are arranged perpendicularly to one another. A pipe assembly 101 having additional elbow bends (not shown) is also envisaged, each having a different arrangement of planes, directions and angles.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

1. A method of manufacturing a double-walled elbow pipe segment, comprising the steps of:
(a) providing an inner pipe member;
(b) providing at least one first support member, and positioning said at least one first support member coaxially over said inner pipe member;
(c) providing an outer pipe member and slidably positioning said assembled inner pipe member and said at least one first support member within said outer pipe member such that said at least one first support member is supportingly engaged with an outer surface of said inner pipe member and an inner surface of said outer pipe member, and
(d) bending a pipe assembly of said inner pipe member, said at least one first support member and said outer pipe member into at least one first elbow section of a predetermined first angle and in a predetermined first direction between an upstream end portion and a downstream end portion of said pipe assembly.

2. A method according to claim 1, wherein step (d) comprises bending said pipe assembly into at least one second elbow section of a predetermined second angle and in a predetermined second direction between said upstream end portion and said downstream end portion.

3. A method according to claim 2, wherein said first direction and said second direction are within the same plane.

4. A method according to claim 2, wherein said first direction and said second direction are within different planes.

5. A method according to claim 2, wherein said first predetermined angle is equal to said second predetermined angle.

6. A method according to claim 2, wherein said first predetermined angle differs from said second predetermined angle.

7. A method according to claim 2, wherein said at least one first support member is adapted to operably cover said at least one first elbow section and said at least one second elbow section.

8. A method according to claim 2, wherein step (b) further comprises providing at least one second support member and positioning said at least one second support member coaxially over said inner pipe member at said second elbow section.

9. A method according to claim 1, wherein step (d) is performed utilising a cold-forming pipe bending tool.

10. A method according to claim 1, further comprising a step (e) verifying a minimally deformed cross-sectional profile of said inner pipe utilizing a ball bearing having a diameter adapted to tightly fit inside said inner pipe member.

11. A pipe assembly, comprising:
an inner pipe member;
an outer pipe member, adapted to operably receive said inner pipe member, so as to define an interstitial space between an outer wall of said inner pipe member and an inner wall of said outer pipe member, as well as, between an upstream end portion and a downstream end portion; and
at least one first support member, adapted to be provided coaxially within said interstitial space so as to supportingly engage said inner wall of said outer pipe member and said outer wall of said inner pipe member, when forming at least one first elbow section, and to provide a fluid path between said upstream end portion and said downstream end portion.

12. A pipe assembly according to claim 11, wherein said at least one first support member is arranged around said inner pipe member in the form of a helix.

13. A pipe assembly according to claim 11, wherein said at least one first support member is a coil spring having a predetermined length.

14. A pipe assembly according to claim 11, further comprising at least one second support member adapted to be provided coaxially within said interstitial space so as to supportingly engage said inner wall of said outer pipe member and said outer wall of said inner pipe member when forming at least one second elbow section, and to provide a fluid path between said upstream end portion and said downstream end portion.

15. A pipe assembly according to claim 11, wherein said pipe assembly is a fuel pipe assembly.

16. A pipe assembly according to claim 11, wherein said outer pipe member comprises carbon steel.

17. A pipe assembly according to claim 11, wherein any one of said outer wall of said inner pipe member and said inner wall of said outer pipe member comprises a protective coating.

18. A pipe assembly according to claim 17, wherein said protective coating comprises zinc.
